(19) United States
(12) Patent Application Publication
(10) Pub. No.: US 2005/0123463 A1
(43) Pub. Date: Jun. 9, 2005

(54) Treatment of exhaust gases

(76) Inventors: Andrew James Seeley, Bristol (GB); Michael Roger Czerniak, Partridge Green (GB)

Correspondence Address: The BOC Group, Inc.;Legal Services-Intellectual Property, 575 Mountain Ave., Murray Hill, NJ, 07974, US

(21) Appl. No.: 10/729,454

(22) Filed: Dec. 5, 2003

(51) Int. Cl. B01D 53/58

(52) U.S. Cl. 423/237; 422/177; 422/172; 422/173

(57) ABSTRACT

An exhaust gas from a chemical vapour deposition process may contain ammonia and metalorganic vapour, such as TMG. In a treatment process to remove these substances from the exhaust gas, the exhaust gas is exposed to an ammonia decomposition catalyst to convert the ammonia into nitrogen and hydrogen. In order to avoid deposition of carbon on the surface of the catalyst, the exhaust gas is first exposed to a heated bed of dry, granular materials to cause the metalorganic vapour to decompose before the exhaust gas is exposed to the aluminium decomposition catalyst.

### FIELD OF THE INVENTION

The invention relates to the treatment of exhaust gases and to the treatment of exhaust gases from a chemical vapour deposition process.

### BACKGROUND OF THE INVENTION

GaN, and related material alloys (such as InGaN, AlGaN and InGaAlN) are compound semiconductors used for the manufacture of green, blue and white light emitting devices (such as LEDs and laser diodes) and power devices (such as HBTs and HEMTs).

These compound semiconductors are formed using a gas-based process usually known as MOCVD (metal organic chemical vapour deposition), OMCVD, MOVPE (metal organic vapour phase epitaxy) or OMVPE. In overview, this process involves reacting together volatile metalorganic sources of the group III metals Ga, In and/or Al, such as trimethyl gallium (TMG), trimethyl indium (TMI) and trimethyl aluminium (TMA), with ammonia at elevated temperatures to form thin films of material on wafers of a suitable substrate material (such as Si, SiC, sapphire or AlN). Significant flows of hydrogen gas are usually also present.

Treatment of the ammonia in the exhaust gas is required as only a small fraction of this gas is utilised in the reaction process, and as this gas is toxic (TLV=25 ppm) and extremely pungent. Conventional treatment methods include incineration, wet scrubbing and catalytic decomposition. However, there are drawbacks associated with each of those treatments.

In an incineration treatment significant flows of ammonia are oxidised. The resultant exhaust gas typically contains high levels of nitrogen oxides (NOx), usually well in excess of levels permitted by law.

With respect to wet scrubbing, since ammonia is highly soluble in water, this is the traditional treatment strategy. However, the cost of water and water disposal make wet scrubbing treatment expensive. Furthermore, acid dosing, often employed to increase the scrubbing efficiency, results in the discharge of ammonium ions into the drain. In many territories, there are absolute discharge limits for such ions.

Catalytic treatment involves using a heated catalyst medium to decompose the ammonia back into its original constituents, namely nitrogen and hydrogen, which may then be discharged back into the atmosphere or incinerated. The drawback with this approach is that typically the metalorganic vapours that are still present in the exhaust gas stream decompose on the hot catalyst bed to form non-volatile carbon precipitates that prevent (or “poison”) the catalyst surface from contacting the ammonia and thereby prevent further decomposition. As a result, this process results in a progressive reduction in the treatment efficiency of the scrubber.

In at least its preferred embodiments, the present invention seeks to solve these and other problems.

### SUMMARY OF THE INVENTION

In a first aspect, the present invention provides a method of treating an exhaust gas containing ammonia and a metalorganic vapour, the method comprising first at least partially removing the metalorganic vapour from the exhaust gas, and then exposing the exhaust gas to an ammonia decomposition catalyst.

### BRIEF DESCRIPTION OF THE DRAWINGS

FIG. 1 is a diagrammatical sectional view through one form of gas conditioning unit;

FIG. 2 illustrates the packing of material within the unit; and

FIG. 3 illustrates an alternative arrangement for the material packing.

### DETAILED DESCRIPTION OF THE INVENTION

In a first aspect, the present invention provides a method of treating an exhaust gas containing ammonia and a metalorganic vapour, the method comprising first at least partially removing the metalorganic vapour from the exhaust gas, and then exposing the exhaust gas to an ammonia decomposition catalyst.

In order to remove the metalorganic vapour from the exhaust gas, the metalorganic vapour may be absorbed by an absorber located upstream from the ammonia decomposition catalyst. Alternatively, the metalorganic vapour is preferably decomposed before the exhaust gas is exposed to the ammonia decomposition catalyst, for example, by exposing the exhaust gas to a heated bed of material(s). Thus, in another aspect, the present invention provides a method of treating an exhaust gas containing ammonia and a metalorganic vapour, the method comprising exposing the exhaust gas to a heated bed of one or more materials to cause the metalorganic vapour to decompose, and then exposing the exhaust gas to an ammonia decomposition catalyst.

In one embodiment, the exhaust gas is conveyed firstly into a first chamber containing the bed of materials and subsequently into a second chamber containing the catalyst. In another embodiment, the exhaust gas is conveyed into a single chamber sub-divided by the materials and the catalyst into two zones. The catalyst may be heated to decompose the ammonia into nitrogen and hydrogen, and may comprise, for example, nickel supported on pellets of a ceramic former.

The metalorganic vapour typically comprises a metal-alkyl material containing a group III metal. For instance, the metalorganic vapour may comprise at least one of trimethyl gallium, trimethyl indium, and trimethyl aluminium, which is decomposed upon exposure to dry heated granular materials, such as, in turn, a metal and a metal oxide.

In another aspect, the present invention provides apparatus for treating an exhaust gas containing ammonia and a metalorganic vapour, the apparatus comprising means for at least partially removing the metalorganic vapour from the exhaust gas, and means for subsequently exposing the exhaust gas to an ammonia decomposition catalyst.

The present invention also provides apparatus for treating an exhaust gas containing ammonia and a metalorganic, the apparatus comprising means for exposing the exhaust gas to a heated bed of one ore more materials to decompose the metalorganic vapour, and subsequently to a heated ammonia decomposition catalyst to decompose the ammonia.

Thus, in accordance with the invention, the metalorganic vapour is pre-treated before the exhaust gas is exposed to the catalyst bed. As a result, carbon deposition is initially confined to the surface of the material in the pre-treatment stage, the ammonia decomposition catalyst initially remaining substantially free from carbon deposits. Once the outer surfaces of the material in the pre-treatment stage have become coated with carbon deposits, the catalyst will start to be exposed to the metalorganic vapours, but nonetheless it is anticipated that with such an arrangement the life of the catalyst could be increased by around 2 to 3 months per kilogram of metalorganic vapours consumed.

Preferred features of the present invention will now be described, by way of example only, with reference to the accompanying drawings.

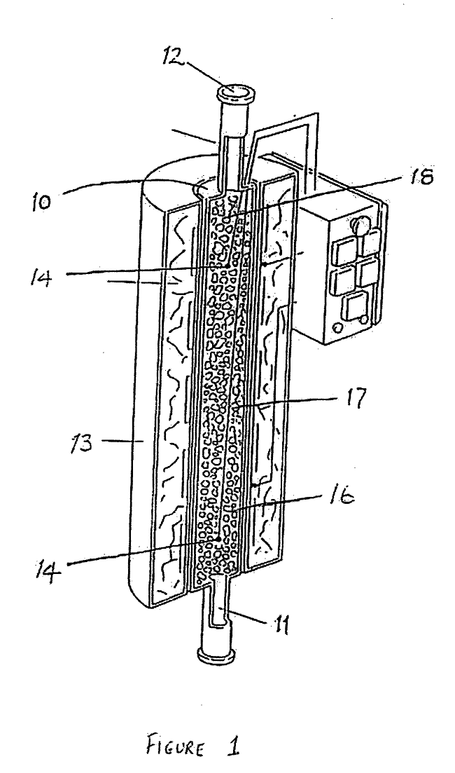

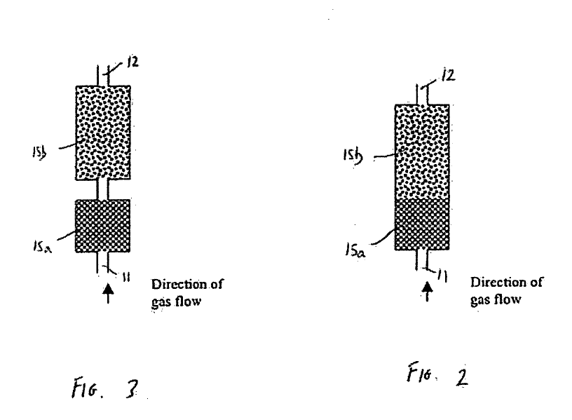

In the illustrated example of FIG. 1 the unit comprises a common vertical cylinder or column 10, which is in the form of a removable cartridge, having an exhaust gas inlet 11 at the lower end and an outlet 12 at the upper end. The column is surrounded by an electrically heated furnace 13 and there may be a spaced control thermocouples 14 at different levels. As shown in FIG. 2, the column is divided into two sections within the same common cylinder. The bottom section 15a comprises a first part 16 containing metal granules and a second part 17 containing granules of a metal oxide. The top section 15b contains an ammonia decomposition catalyst 18. In the preferred embodiment, the bottom section 15a extends roughly one third up the cylinder, with the metal granules occupying the first (upstream) half of the bottom section 15a and the metal oxide granules occupying the second (downstream) half of the bottom 15a.

In use, a gas containing ammonia and a metalorganic vapour, such as trimethyl gallium (TMG), trimethyl indium (TMI) and trimethyl aluminium (TMA), which is exhaust from a chemical vapour deposition process enters the cylinder 10 through gas inlet 11. The gas is first heated by passing through a bed of dry, granular metal such as silicon at an elevated temperature, for example in the range from 200° C. to 700° C. The metal can be contained in any suitable container, for example, stainless steel or quartz, with heat supplied through the walls of the container as shown in FIG. 1 or, alternatively, through induction heating or an internally placed heat source. Although silicon is used in the preferred embodiment, any suitable material for transferring heat to the exhaust gas may be employed.

The hot gases emerging from the metal bed then pass through a bed of hot, dry, granulated metal oxide, such as lime. The hot metal oxide causes any group III metalorganic vapour, for example, TMG, to decompose into its constituent elements, namely hydrogen, which passes through the metal oxide bed, carbon, which coats surface of the metal oxide granules, and a group III metal, which falls to the bottom of the cylinder where it may be collected for recycling. Again, although lime is used in the preferred embodiment, any suitable material for causing the metalorganic vapour to decompose may be employed.

As a result of passing through the bottom section 15a of the cylinder, and thus having been exposed to the hot metal and metal oxide granules, the exhaust gas is substantially free from metalorganic vapour upon entering the top section 15b of the cylinder. As a result, the ammonia decomposition catalyst, for example, heated pellets of a ceramic coated with nickel, remains substantially free from carbon deposition until the bottom section 15a becomes “exhausted”, that is, when the outer surfaces of the metal oxide become fully coated with carbon deposits. Nonetheless it is anticipated that with such an arrangement the life of the catalyst could be increased by around 2 to 3 months per kilogram of metalorganic vapour consumed.

Exhaustion for the bottom section 15a can be conveniently predicted by monitoring the amount of metalorganic vapour entering the cartridge. This can enable the cartridge to be replaced at a convenient time, for instance, when the process tool is “off-line”, after a predetermined amount of metalorganic vapour, say, 2 kg, has entered the cartridge. The materials in the replaced cartridge can then be recycled as required.

In summary, an exhaust gas from a chemical vapour deposition process may contain ammonia and metalorganic vapour. In a treatment process to remove these substances from the exhaust gas, the exhaust gas is exposed to an ammonia decomposition catalyst to convert the ammonia into nitrogen and hydrogen. In order to avoid deposition of carbon on the surface of the catalyst, the exhaust gas is first exposed to a heated bed of dry, granular materials to cause the metalorganic vapour to decompose before the exhaust gas is exposed to the aluminium decomposition catalyst.

It is to be understood that the foregoing represents one embodiment of the invention, others of which will no doubt occur to the skilled addressee without departing from the true scope of the invention as defined by the claims appended hereto.

For example, in an alternative embodiment illustrated in FIG. 3, the materials in the bottom section 15a and top section 15b of the cartridge may be “divided” into separate cartridges. Thus, once the bottom section 15a has, or is about to become, exhausted, it would be necessary to replace the bottom section 15a only. Two or more cartridges containing metal and metal oxide granules may be connected in series upstream of the cartridge containing the ammonia decomposition catalyst. Capacity may be increased by providing multiple cartridges connected in parallel.

While the foregoing description and drawings represent the preferred embodiments of the present invention, it will be apparent to those skilled in the art that various changes and modifications may be made therein without departing from the true spirit and scope of the present invention.

1. A method of treating an exhaust gas containing ammonia and metalorganic vapour, the method comprising: partially removing the metalorganic vapour from the exhaust gas; and exposing the exhaust gas to an ammonia decomposition catalyst.

2. The method according to claim 1, wherein the metalorganic vapour is removed by partially decomposing the metalorganic vapour within the exhaust gas.

3. The method according to claim 2, wherein the metalorganic vapour is decomposed by exposing the exhaust gas to a heated bed of one or more materials.

4. A method of treating an exhaust gas containing ammonia and metalorganic vapour, the method comprising: exposing the exhaust gas to a heated bed of material to cause the metalorganic vapour to decompose, and then exposing the exhaust gas to an ammonia decomposition catalyst.

5. The method according to claim 4, wherein the exhaust gas is conveyed into a first chamber containing the heated bed and subsequently into a second chamber containing the catalyst.

6. The method according to claim 4, wherein the exhaust gas is conveyed into a single chamber sub-divided into two zones by the heated bed and the catalyst.

7. The method according to claim 4, wherein the catalyst is heated to decompose the ammonia into nitrogen and hydrogen.

8. The method according to claim 7, wherein the catalyst comprises nickel supported on a ceramic former.

9. The method according to claim 4, wherein the metalorganic vapour comprises a metal-alkyl vapour.

10. The method according to claim 4, wherein the metalorganic vapour comprises a group III metal.

11. The method according to claim 10, wherein the metalorganic vapour comprises at least one of trimethyl gallium, trimethyl indium, and trimethyl aluminium.

12. The method according to claim 4, wherein the heated bed comprises a metal and a metal oxide.

13. The method according to claim 12, wherein the exhaust gas is exposed to the heated metal and the exhaust gas exposed to the heated metal is exposed to the heated metal oxide.

14. An apparatus for treating an exhaust gas containing ammonia and metalorganic vapour, the apparatus comprising: means for partially removing the metalorganic vapour from the exhaust gas, and means for exposing the exhaust gas to an ammonia decomposition catalyst.

15. The apparatus according to claim 14, wherein the removing means comprises means for partially decomposing the metalorganic vapour within the exhaust gas.

16. The apparatus according to claim 14, wherein the removing means comprises means for exposing the exhaust gas to a heated bed of one or more materials for causing the metalorganic vapour to decompose.

17. An apparatus for treating an exhaust gas containing ammonia and metalorganic vapour, the apparatus comprising: exposing means for exposing the exhaust gas to a heated bed of one or more materials to cause the metalorganic vapour to decompose and for subsequently exposing the exhaust gas to an ammonia decomposition catalyst.

18. An apparatus according to claim 17, wherein the exposing means comprises first and second sequential stages in communication with each other and through which the exhaust gases pass during treatment, the first stage containing the heated bed and the second stage containing the catalyst.

19. An apparatus according to claim 17, wherein the exposing means comprises a single gas treatment chamber subdivided into two zones by the heated bed and the catalyst.

20. An apparatus according to claim 19, wherein the exposing means comprises a replaceable cartridge.

21. An apparatus according to claim 18, wherein the exposing means comprises a first chamber containing the heated bed and a second chamber downstream from the first chamber containing the catalyst.

22. An apparatus according to claim 17, comprising means for heating the catalyst to decompose the ammonia into nitrogen and hydrogen.
